(19) United States
(12) Patent Application Publication
(10) Pub. No.: US 2026/0300083 A1
(43) Pub. Date: Oct. 1, 2026

(54) METHOD AND APPARATUS FOR REPAIRING CALL CHAIN, DEVICE, AND PRODUCT

(71) Applicant: Beijing Zitiao Network Technology Co., Ltd., Beijing (CN)

(72) Inventors: Cheng Guo, Beijing (CN); Jianhua Zhu, Beijing (CN); Hengjie Zheng, Beijing (CN)

(21) Appl. No.: 19/578,391

(22) Filed: Mar. 25, 2026

(30) Foreign Application Priority Data
Mar. 25, 2025 (WO) PCT/CN2025/084814

(51) Int. Cl. G06F 11/07

(52) U.S. Cl. CPC G06F 11/0793; G06F 11/0745

(57) ABSTRACT

The present disclosure relates to a method and apparatus for repairing a call chain, a device, and a product. The method includes acquiring a source code of a first service in the call chain, where the call chain also includes a second service, and a call relationship between the first service and the second service is unknown. The method further includes acquiring an interface incoming parameter of the first service. The method further includes determining the call relationship between the first service and the second service based on the source code and the interface incoming parameter. Additionally, the method further includes generating a repaired call chain based on the call relationship.

### CROSS-REFERENCE TO RELATED APPLICATION(S)

This application claims priority to International Patent Application No. PCT/CN2025/084814 filed on Mar. 25, 2025, the disclosure of which is incorporated herein by reference in its entity.

### FIELD

The present disclosure relates to the field of software development, and more specifically, to a method and apparatus for repairing a call chain, a device, and a product.

### BACKGROUND

In a distributed system, a call chain trace is a crucial technology used to trace and record call relationships between various services and components in the system. By propagating trace information across the services, the call chain trace can assist development engineers and operation and maintenance engineers in monitoring system behaviors in real time, and analyzing the flow and processing processes of requests, thereby identifying performance bottlenecks, locating issues, and optimizing system performance. Commonly used call chain trace technologies include Jaeger, Zipkin, etc., which provide cross-service link tracing functions to ensure effective tracing of the lifecycle of each request in a complex distributed architecture, thereby enhancing system observability and reliability.

### SUMMARY

In a first aspect of embodiments of the present disclosure, a method for repairing a call chain is provided. The method includes acquiring a source code of a first service in the call chain, wherein the call chain further includes a second service, and a call relationship between the first service and the second service is unknown. The method further includes acquiring an interface incoming parameter of the first service. The method further includes determining the call relationship between the first service and the second service based on the source code and the interface incoming parameter. Additionally, the method further includes generating a repaired call chain based on the call relationship.

In a second aspect of the embodiments of the present disclosure, an apparatus for repairing a call chain is provided. The apparatus includes a source code acquiring module, configured to acquire a source code of a first service in the call chain, wherein the call chain also includes a second service, and a call relationship between the first service and the second service is unknown. The apparatus further includes an incoming parameter acquisition module, configured to acquire an interface incoming parameter of the first service. The apparatus further includes a call relationship determination module, configured to determine the call relationship between the first service and the second service based on the source code and the interface incoming parameter. Additionally, the apparatus further includes a call chain repair module, configured to generate a repaired call chain based on the call relationship.

In a third aspect of the embodiments of the present disclosure, an electronic device is provided. The electronic device includes one or more processors; and a storage apparatus, configured to store one or more programs. The one or more programs, when executed by the one or more processors, cause the one or more processors to implement a method for repairing a call chain. The method includes acquiring a source code of a first service in the call chain, wherein the call chain further includes a second service, and a call relationship between the first service and the second service is unknown. The method further includes acquiring an interface incoming parameter of the first service. The method further includes determining the call relationship between the first service and the second service based on the source code and the interface incoming parameter. Additionally, the method further includes generating a repaired call chain based on the call relationship.

In a fourth aspect of the embodiments of the present disclosure, a computer program product is provided. The computer program product is tangibly stored on a non-transitory computer-readable medium and includes machine-executable instructions, and the machine-executable instructions, when executed, causes a machine to implement a method for repairing a call chain. The method includes acquiring a source code of a first service in the call chain, wherein the call chain further includes a second service, and a call relationship between the first service and the second service is unknown. The method further includes acquiring an interface incoming parameter of the first service. The method further includes determining the call relationship between the first service and the second service based on the source code and the interface incoming parameter. Additionally, the method further includes generating a repaired call chain based on the call relationship.

The section SUMMARY is provided to introduce the selection of concept in a simplified form, which will be further described in the following DETAILED DESCRIPTION OF EMBODIMENTS. The section SUMMARY is not intended to identify key or essential features of the subject claimed for protection, nor is it intended to limit the scope of the subject claimed for protection.

### BRIEF DESCRIPTION OF THE DRAWINGS

The above and other features, advantages, and aspects of various embodiments of the present disclosure will become more apparent in conjunction with the accompanying drawings and with reference to following detailed descriptions. In the accompanying drawings, the same or similar reference numerals denote the same or similar elements.

FIG. 1 illustrates a schematic diagram of an example environment wherein a plurality of embodiments of the present disclosure may be implemented;

FIG. 2 illustrates a flowchart of a method for repairing a call chain according to some embodiments of the present disclosure;

FIG. 3 illustrates a schematic diagram of an example of a system architecture for repairing a call chain according to some embodiments of the present disclosure;

FIG. 4A to FIG. 4F illustrate schematic diagrams of example processes of repairing a call chain according to some embodiments of the present disclosure;

FIG. 5 illustrates a schematic diagram of an example of an interaction between a processing device and a client according to some embodiments of the present disclosure;

FIG. 6 illustrates a block diagram of an apparatus for repairing a call chain according to some embodiments of the present disclosure; and

FIG. 7 illustrates a block diagram of a device capable of implementing a plurality of embodiments of the present disclosure.

### DETAILED DESCRIPTION OF EMBODIMENTS

It should be understood that all user-related data involved in the technical solution should be acquired and used after user authorization, which means that in the technical solution, if personal information of a user needs to be used, explicit consent and authorization from the user are required before acquiring these data, otherwise, relevant data collection and use will not be carried out. It should also be understood that when the technical solution is implemented, relevant laws and regulations should be strictly followed in the process of data collection, use, and storage, and necessary technologies and measures should be taken to ensure the security of user data and the safe use of the data.

The embodiments of the present disclosure will be described in more detail below with reference to the accompanying drawings. Although the accompanying drawings show some embodiments of the present disclosure, it should be understood that the present disclosure may be implemented in various forms, and should not be construed as being limited to the embodiments stated herein. On the contrary, these embodiments are provided for a more thorough and complete understanding of the present disclosure. It should be understood that the accompanying drawings and the embodiments of the present disclosure are for exemplary purposes only, and are not intended to limit the scope of protection of the present disclosure.

In the description of the embodiments of the present disclosure, the term “include” and similar terms thereof should be understood as open-ended inclusions, namely, “including but not limited to”. The term “based on” should be understood as “at least partially based on”. The term “an embodiment” or “this embodiment” should be understood as “at least one embodiment”. The terms “first”, “second”, etc. may refer to different or identical objects, unless otherwise explicitly specified. Other explicit and implicit definitions may also be included below.

In a modern distributed system, a call chain trace can assist development engineers and operation maintenance engineers in gaining a comprehensive understanding of system behaviors and performance by tracing a circulation path of requests across different services. Based on the call chain trace, development teams can accurately identify system performance bottlenecks, diagnose potential issues in the system, and even predict system load and pressure, thereby allowing for optimization or adjustments before the issues occur. In addition, systems like Jaeger and Zipkin can provide a complete tracing function, ensuring precise tracing of a path of each request in a complex microservice architecture, thereby enhancing system observability and reliability.

In practical applications, by integrating a plurality of call chain traces in the same business scenario, a complete business call chain can be formed. For example, in business scenarios such as a live streaming business, a social business, or an e-commerce business, the call chain trace not only assists the engineers in tracing call conditions of various services but also in analyzing a dependency relationship between the services. Through the method, the engineers can more clearly understand interactions between different services, quickly locate a source of the issues, analyze potential impacts caused by system changes, or optimize business logic. Additionally, the business call chain may also support in-depth dependency analysis and fault localization, thereby improving system reliability and user experience.

However, to implement a complete call chain trace, each service in the system needs to be correctly integrated with a call chain trace component and reasonably transmit context information in code. Only by transmitting trace data upstream and downstream across the plurality of services for each request can trace information for these requests be ensured to be complete. If a service fails to correctly transmit the context information to a downstream service, a broken call chain may be caused, meaning that call information for certain links in link tracing is missing. The problem about the broken chain may arise due to services not correctly integrating the call chain trace components, loss of context, misconfiguration, or the like.

To repair the broken chain, the engineers are prompted to integrate the call chain trace components in the code and correctly transmit the context information. However, the method requires integrating the call chain trace component in each service, and in the process, performance consumption may be increased. Some applications with stringent performance requirements may not be able to tolerate the performance consumption caused by adding the call chain trace components. Some related technologies supplement broken chain information by statically analyzing call relationships between the services. For example, these technologies can automatically infer call chains by analyzing a call graph between the services. However, while these technologies can achieve a certain degree of automation, these technologies are low in accuracy and are unable to perform a call chain analysis at a business link level.

In view of this, an embodiment of the present disclosure provides a solution for repairing a call chain. the solution, a processing device may acquire a source code of a first service in the call chain, wherein the call chain further includes a second service, and a call relationship between the first service and the second service is unknown. Additionally, the processing device may also acquire an interface incoming parameter of the first service. Then, the processing device may determine the call relationship between the first service and the second service based on the source code and the interface incoming parameter. Then, the processing device may generate a repaired call chain based on the call relationship.

Through the method, the processing device can achieve a combined dynamic and static program analysis based on the source code of the service and the dynamically acquired interface incoming parameter, thereby improving the accuracy of the repaired call chain. When a value of the interface incoming parameter is changed, the processing device can repair the call chain for different business scenarios, thereby achieving the call chain analysis at the business link level.

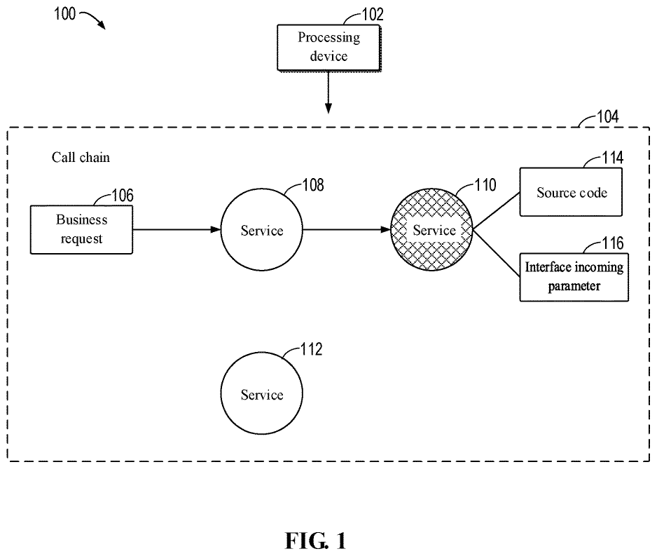

FIG. 1 illustrates a schematic diagram of an example environment 100 wherein a plurality of embodiments of the present disclosure may be implemented. As shown in FIG. 1, the environment 100 includes a processing device 102. The processing device 102 may be any device with a processing capability or a computing capability. For example, the processing device 102 may be a cloud server, a local server, a virtual server, a desktop computer, a laptop computer, or the like.

In the environment 100, the processing device 102 may acquire a call chain 104 with a broken chain. The call chain 104 includes a business request 106, a service 108, a service 110, and a service 112. The service 108 may be integrated with a call chain trace component and transmit context information to a downstream service (i.e., the service 110). Therefore, in an example shown in the environment 100, a call relationship among the business request 106, the service 108, and the service 110 is known. That is, the business request 106 calls the service 108, and the service 108 calls the service 110. However, the call chain 104 is broken at the service 110, which may be due to, for example, the service 110 being not integrated with the call chain trace component or not transmitting the context information to the downstream service. Additionally, the service 112 may also be included in the broken call chain 104. In the example shown in the environment 100, the service 110 actually calls the service 112. However, because the service 110 is not integrated with the call chain trace component or does not transmit the context information to the service 112, the system cannot recognize the call relationship between the service 110 and the service 112, making the call relationship between the service 110 and the service 112 unknown (also referred to as being unrecognized).

In the environment 100, to repair the broken chain at the service 110, the processing device 102 may acquire a source code 114 of the service 110. The source code 114 is code and a logical implementation used to construct the service 110, which may be written by developers using programming languages (e.g., C, C++, Java, Python, and Go). The source code 114 may define a function, a data processing logic, etc., of the service 110. Additionally, the processing device 102 may also acquire an interface incoming parameter 116 of the service 110. In some embodiments, the processing device 102 may capture the interface incoming parameter 116 through dynamic interception in an operation process of the service 110. In some embodiments, the processing device 102 may acquire an enumeration value of a business parameter configured by the user as the interface incoming parameter 116 to simulate a dynamic incoming parameter of the service 110. In some embodiments, the interface incoming parameter 116 may include a business scenario parameter, which may be an enumeration value indicating a current business type, such as live streaming, social networking, and e-commerce. In some embodiments, the interface incoming parameter 116 may also include a business logic parameter, which may be associated with a business logic performed on data under a specific business scenario, such as a data storage method.

In the environment 100, the processing device 102 may determine the call relationship between the service 110 and the service 112 based on the source code 114 of the service 110 and the dynamically acquired interface incoming parameter 116. For example, the source code 114 may include a plurality of data flows corresponding to a plurality of business scenarios. The processing device 102 may recognize the corresponding business scenario by parsing the interface incoming parameter 116. Additionally, the processing device may also recognize a conditional statement (e.g., an “if” statement and a “switch” statement) in the source code 114. Then, the processing device 102 may determine an actual flow direction of the data at the conditional statement based on the interface incoming parameter 116. By analyzing a data flow path, the processing device 102 may recognize that, under the specific business scenario, the data flows from the service 110 to the service 112 (i.e., the service 110 calls the service 112). Therefore, the processing device 102 may determine that, under the business scenario, the call relationship from the service 110 to the service 112 exists.

After determining the call relationship between the service 110 and the service 112, the processing device 102 may supplement the call relationship into the call chain 104 to generate a repaired call chain. In the environment 100, the service 112 may be a node without a broken chain or a node with a broken chain. If the service 112 is the node with the broken chain, the processing device 102 may acquire a source code and an interface incoming parameter of the service 112 and perform a process similar to the above process to repair the broken chain at the service 112.

It should be understood that although a specific number of services and specific call relationships between the services are shown in the environment 100, they are not intended to limit the number of services and the call relationships between the services. In some embodiments, the call chain may have more or fewer services, and various call relationships may exist between the services. For example, in addition to the service 110, the service 108 may also call other services simultaneously.

Through the method, the processing device can achieve a combined dynamic and static program analysis based on the source code 114 of the service 110 and the dynamically acquired interface incoming parameter 116, thereby improving the accuracy of the repaired call chain 104. When a value of the interface incoming parameter 116 is changed, the processing device 102 can repair the call chain 104 for different business scenarios, thereby achieving the call chain analysis at a business link level.

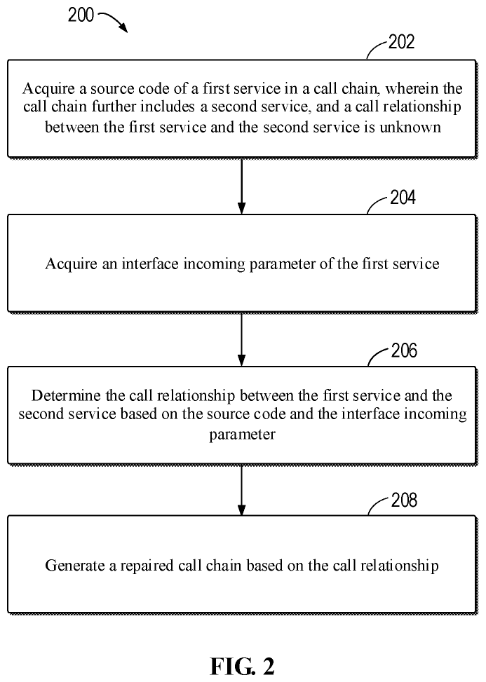

FIG. 2 illustrates a flowchart of a method 200 for repairing a call chain according to some embodiments of the present disclosure. The method 200 may be performed by a processing device. For example, the method 200 may be performed by the processing device 102 in FIG. 1. As shown in FIG. 2, at a block 202, the processing device may acquire a source code of a first service in the call chain, wherein the call chain further includes a second service, and a call relationship between the first service and the second service is unknown. For example, in the environment 100 shown in FIG. 1, although the service 110 calls the service 112, because the service 110 is not integrated with the call chain trace component or does not transmit the context information to the service 112, the system cannot recognize the call relationship between the service 110 and the service 112, making the call relationship between the service 110 and the service 112 unknown. In other words, the call chain 104 is broken at the service 110. To repair the broken chain at the service 110, the processing device 102 may acquire the source code 114 of the service 110.

At a block 204, the processing device may also acquire an interface incoming parameter of the first service. For example, in the environment 100 shown in FIG. 1, the processing device 102 may also acquire the interface incoming parameter 116 of the service 110. In some embodiments, the processing device 102 may capture the interface incoming parameter 116 through dynamic interception in the operation process of the service 110. In some embodiments, the processing device 102 may acquire an enumeration value of a business parameter configured by the user as the interface incoming parameter 116 to simulate a dynamic incoming parameter of the service 110. In some embodiments, the interface incoming parameter 116 may include a business scenario parameter, which may be an enumeration value indicating a current business type. In some embodiments, the interface incoming parameter 116 may also include a business logic parameter, which may be associated with a business logic performed on data under a specific business scenario.

At a block 206, the processing device may determine the call relationship between the first service and the second service based on the source code and the interface incoming parameter. For example, in the environment 100 shown in FIG. 1, the processing device 102 may determine the call relationship between the service 110 and the service 112 based on the source code 114 of the service 110 and the dynamically acquired interface incoming parameter 116. For example, the source code 114 may include a plurality of data flows corresponding to a plurality of business scenarios. The processing device 102 may recognize the corresponding business scenario by parsing the interface incoming parameter 116. Additionally, the processing device may also recognize a conditional statement in the source code 114, and determine an actual flow direction of the data at the conditional statement based on the interface incoming parameter 116. By analyzing a data flow path, the processing device 102 may recognize that, under the specific business scenario, the data flows from the service 110 to the service 112. Therefore, the processing device 102 may determine that, under the business scenario, the call relationship from the service 110 to the service 112 exists.

At a block 208, the processing device may generate a repaired call chain based on the call relationship. For example, in the environment 100 shown in FIG. 1, after determining the call relationship between the service 110 and the service 112, the processing device 102 may supplement the call relationship into the call chain 104 to generate the repaired call chain.

Through the method, the processing device can achieve a combined dynamic and static program analysis based on the source code of the service and the dynamically acquired interface incoming parameter, thereby improving the accuracy of the repaired call chain. When a value of the interface incoming parameter is changed, the processing device can repair the call chain for different business scenarios, thereby achieving the call chain analysis at a business link level.

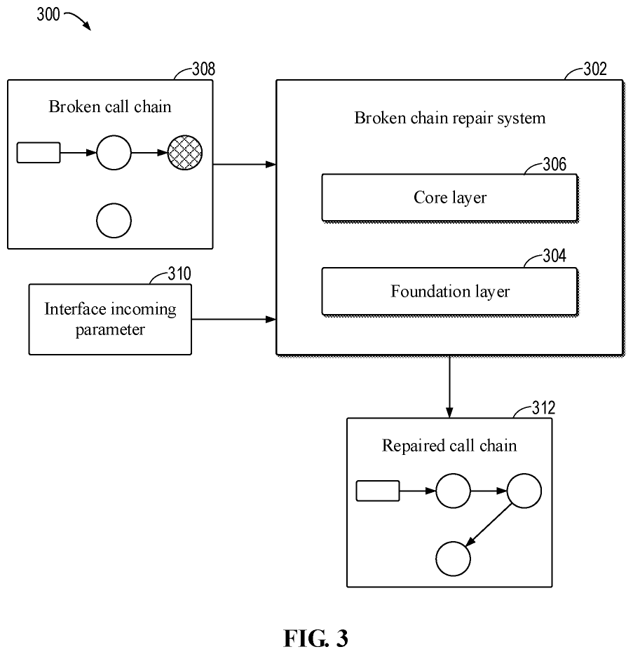

FIG. 3 illustrates a schematic diagram of an example 300 of a system architecture for repairing a call chain according to some embodiments of the present disclosure. As shown in FIG. 3, the example 300 includes a broken chain repair system 302. The broken chain repair system 302 may include a foundation layer 304 and a core layer 306. In the example 300, a call chain 308 with a broken chain may be input into the broken chain repair system 302. The broken chain repair system 302 may determine that a broken chain occurs at a specific service (also referred to as a target service) in the call chain 308 (e.g., the service 110 in FIG. 1). Then, the broken chain repair system 302 may acquire a source code of the target service and an interface incoming parameter 310 of the target service.

In some embodiments, to acquire the interface incoming parameter 310 of the target service, the processing device may dynamically intercept input data of the target service in an operation process of the target service to acquire the interface incoming parameter 310. Through the method, data acquisition can be performed through an interceptor, a proxy pattern and so on without directly modifying business logic code of the target service. The method can complete the data acquisition without affecting a normal operation of the service, thereby reducing interference with an existing system. Additionally, in a complex business scenario, dynamic interception may allow more comprehensive collection of parameter information, thereby reducing the likelihood of missing possible values of incoming parameters. Additionally, the method can also enhance the authenticity and reliability of the analyzed data.

In some embodiments, to acquire the interface incoming parameter 310 of the target service, the processing device may acquire a parameter input by the user as the interface incoming parameter of the first service. The user may be an engineer performing a data flow analysis or a maintenance engineer performing the target service. Through the method, the user may simulate various input scenarios and configure different incoming parameters according to testing requirements, thereby ensuring that the system can handle various scenarios. When repairing a business call chain of interest, the method can also enhance the accuracy and controllability of broken chain repair.

In the example 300, the foundation layer 304 of the broken chain repair system 302 may provide an underlying analysis capability. The foundation layer 304 may generate a static abstract syntax tree and a static call chain based on the source code. The foundation layer 304 may also perform dynamic parameter acquisition to acquire a dynamic incoming parameter of the service. The foundation layer 304 may also parse the collected interface incoming parameter to determine a meaning of the interface incoming parameter (e.g., whether the interface incoming parameter is a business scenario parameter or a business logic parameter). The foundation layer 304 may also include a constraint solver that may perform constraint solving on a data flow node with an incomplete meaning to determine a complete meaning of the data flow node (e.g., solving a value of a string constant). The foundation layer 304 may also perform the data flow analysis in the method to determine a flow path of the data in the method.

In the example 300, the core layer 306 may provide a broken chain repair capability for a business link. The core layer 306 may perform the data flow analysis between methods or services. The core layer 306 may also perform a combined dynamic and static control flow analysis based on the static call chain in the service and the dynamically collected interface incoming parameter. The core layer 306 may perform constraint solving on a control flow node (e.g., corresponding to a conditional statement) based on the interface incoming parameter to determine a flow direction of the data at the control flow node.

In the example 300, by using the various capabilities provided by the foundation layer 304 and the core layer 306, the broken chain repair system 302 may repair the broken chain in the call chain 308 based on the static abstract syntax tree, the static call chain, and the interface incoming parameter 310 of the target service to generate a repaired call chain 312. The repaired call chain 312 may indicate an in-application call chain for a given dynamic interface incoming parameter.

In some embodiments, to determine the call relationship between the first service and the second service, the processing device may determine an intra-service call chain of the first service based on the source code and the interface incoming parameter, wherein the intra-service call chain includes a call relationship between a plurality of methods in a single service. Then, the processing device may determine the call relationship between the first service and the second service based on the intra-service call chain. In some embodiments, the processing device may generate an abstract syntax tree corresponding to the source code based on the source code. Then, the processing device may generate a static call chain of the first service based on the abstract syntax tree. Then, the processing device may determine an intra-service call chain based on the static call chain and the interface incoming parameter. In some embodiments, the processing device may determine a control flow node in the source code. Then, the processing device may determine an intra-service call chain based on the static call chain, the control flow node, and the interface incoming parameter.

In some embodiments, the interface incoming parameter includes a business scenario parameter and a business logic parameter. In some embodiments, the control flow node includes a business scenario control flow node associated with a business scenario and a business logic control flow node associated with a business logic. To determine the intra-service call chain, the processing device may determine a first data flow node in the static call chain by solving the business scenario control flow node using the business scenario parameter, wherein the first data flow node is associated with the business logic control flow node, and determine the intra-service call chain based on the first data flow node, the business logic control flow node, and the business logic parameter, wherein the intra-service call chain is associated with the business scenario. In some embodiments, the processing device may determine a second data flow node in the static call chain by solving the business logic control flow node using the business logic parameter. Then, the processing device may determine the intra-service call chain based on the first data flow node and the second data flow node. In some embodiments, the processing device may determine that the second service is called at a target data flow node based on the intra-service call chain. Then, the processing device may determine that the call relationship exists between the first service and the second service based on the determination of the second service being called.

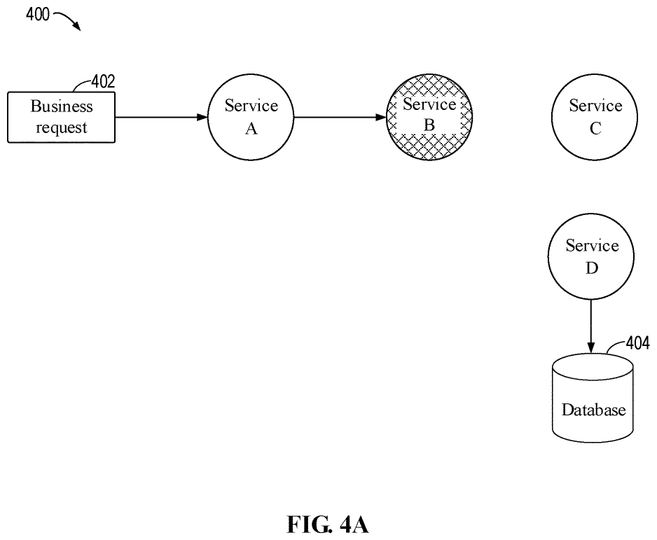

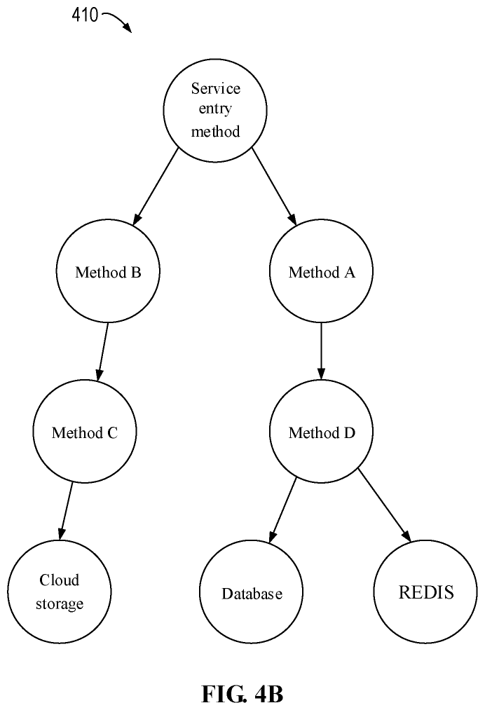

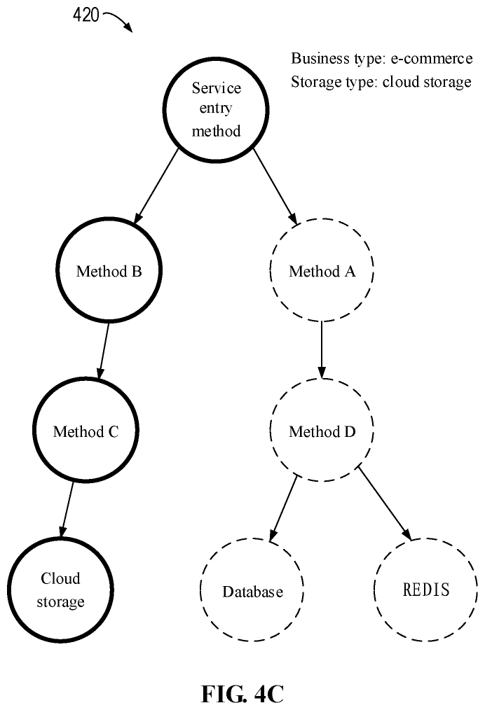

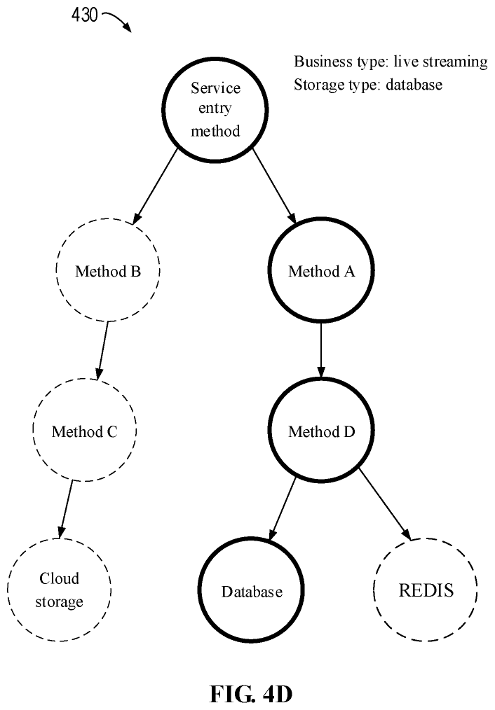

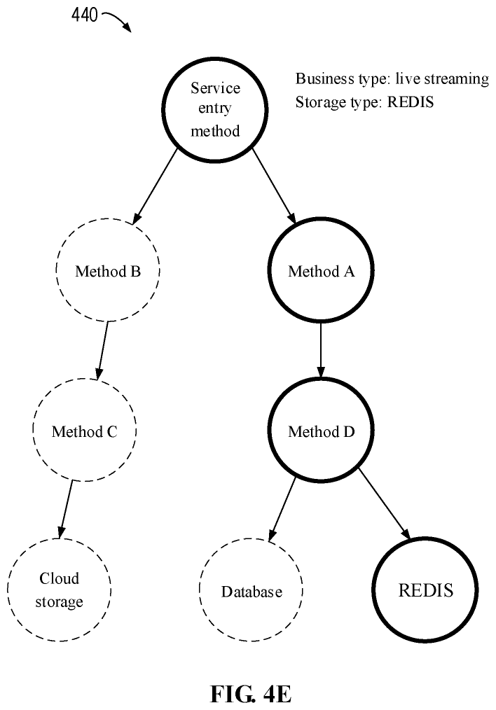

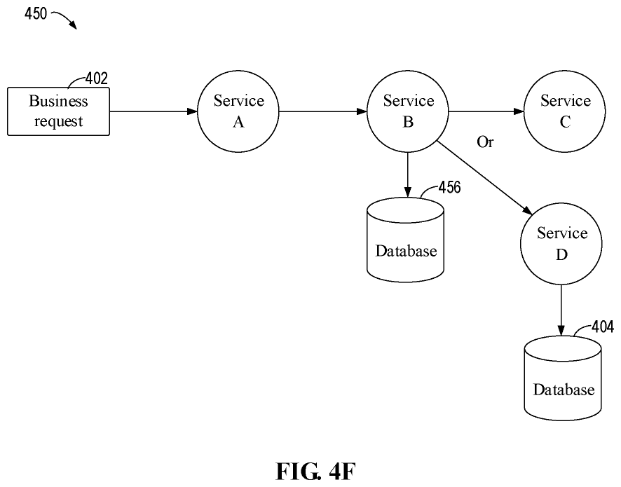

FIG. 4A to FIG. 4F illustrate schematic diagrams of example processes of repairing a call chain according to some embodiments of the present disclosure. FIG. 4A illustrates a schematic diagram of an exemplary call chain 400 to be repaired. FIG. 4B illustrates a schematic diagram of an exemplary static call chain 410 in a target service. FIG. 4C illustrates a schematic diagram of an exemplary business call chain 420 for a pair of business scenario parameter and business logic parameter. FIG. 4D illustrates a schematic diagram of another exemplary business call chain 430 for another pair of business scenario parameter and business logic parameter. FIG. 4E illustrates a schematic diagram of another exemplary business call chain 440 for yet another pair of business scenario parameter and business logic parameter. FIG. 4F illustrates a schematic diagram of a repaired exemplary call chain 450.

As shown in FIG. 4A, the call chain 400 includes a business request 402, a service A, a service B, a service C, a service D, and a database 404, and the call chain 400 may indicate a call relationship among these services. As shown in FIG. 4A, in the call chain 400, the business request 402 calls the service A, the service A calls the service B, and the service D calls the database 404. However, since the service B is not integrated with a call chain trace component or does not transmit upstream-downstream information to a downward service, a broken chain occurs at the service B. In this case, the call chain 400 does not indicate whether the service B calls the service C or the service D. Therefore, the processing device (e.g., the processing device 102 in FIG. 1) may acquire a source code of the service B. The following illustrates an exemplary source code of the service B (shown in pseudocode for ease of understanding):

```
Service Entry Method (business type, storage type) {
  if business type equals to ″e-commerce″ {
    method B (storage type);
  }
  if business type equals to ″live streaming″ {
    method A (storage type);
    }
  }
    method A (storage type); {
      method D (storage type);
  }
    method B (storage type); {
      method C (storage type);
  }
  method C (storage type); {
    call service C;
    store data in cloud storage;
  }
  method D (storage type); {
    call service D;
    if storage type equals to ″REDIS″ {
      store data in REDIS;
    } else {
      store data in database;
    }
  }
```

After acquiring the source code of the service B, the processing device may generate an abstract syntax tree corresponding to the source code based on the source code of the service B. The abstract syntax tree is a tree-like data structure used to represent a syntactic structure of a source code. The abstract syntax tree is an intermediate representation form generated by a compiler and a code analysis tool during the parsing of the source code. In the abstract syntax tree, key elements of the code (e.g., a function, a variable, an operator, and a control flow) may be converted into hierarchical nodes, with each node representing a syntactic element. By generating the abstract syntax tree, a clear logical structure of the code can be obtained. Then, the processing device may generate a static call chain (also known as a static full call chain) of the service B based on the abstract syntax tree of the service B.

The static call chain refers to a path call model constructed by analyzing a call relationship among methods in the source code without running a program. By using a static analysis technology, the processing device may recognize dependencies and call paths among a plurality of methods in the service B at a code level. FIG. 4B illustrates the static call chain 410 in the service B.

As shown in FIG. 4B, by analyzing the source code (or the abstract syntax tree) of the service B, the processing device may determine that, in the service entry method, the method A and the method B are called respectively based on different business types (i.e., business scenario parameters). The method C is called in the method B, and a cloud storage service is called in the method C to store the data in the cloud storage. Additionally, the method D is called in the method A. In the method D, according to different storage types (i.e., business logic parameters), a database (DB) service and a remote dictionary server (REDIS) service are respectively called to store the data in the database or REDIS. After generating the static call chain 410, the processing device may determine an actual business call chain in the service B based on the static call chain 410 and specific values of interface incoming parameters (i.e., the business type and the storage type) of the service B. Then, the processing device may determine a call relationship between the service B and the service C or the service D based on the actual business call chain in the service B.

For example, by dynamically collecting values of the interface incoming parameters, the processing device may determine that the value of the business type is “e-commerce” and the value of the storage type is “cloud storage”. FIG. 4C illustrates the exemplary business call chain 420 of the service B in this case. In the source code of the service B, the interface incoming parameters of the service entry method include the business type and the storage type. By parsing the interface incoming parameters, the processing device may recognize that the business type is the business scenario parameter and the storage type is the business logic parameter. The processing device may recognize a control flow node in the service entry method. The recognized control flow node may correspond to a conditional statement such as the “if” statement or the “switch” statement in the source code.

In the source code of the service B, the control flow node in the service entry method may include “if business type equals to ‘e-commerce’” and “if business type equals to ‘live streaming’”. The processing device may perform constraint solving on the control flow node based on the values of the interface incoming parameters. Since the value of the business type is “e-commerce” in the example shown in FIG. 4C, the condition “business type equals to ‘e-commerce’” is satisfied, and the data flows into the corresponding data flow node (i.e., the method B (storage type)). At the data flow node, the service entry method calls the method B and transmits the value of the storage type (i.e., “cloud storage”) to the method B. The method C is called in the method B, and the value of the storage is transmitted to the method C. In the method C, the service C is called, and the data is stored in the cloud storage. Accordingly, by analyzing the business call chain 420 of the service B, the processing device may determine that the service B calls the service C when the value of the business scenario parameter is “e-commerce” and the value of the business logic parameter is “cloud storage”. Therefore, the processing device may repair the call relationship from the service B to the service C in the business scenario.

FIG. 4D illustrates the exemplary business call chain 430 generated when the value of the business type is “live streaming” and the value of the storage type is “database”. In the example shown in FIG. 4D, at the control flow node in the method entry method, the processing device may perform constraint solving on the control flow node based on the values of the interface incoming parameters. Since the value of the business type is “live streaming”, the condition “business type equals to ‘live streaming’” is satisfied, and the data flows into the corresponding data flow node (i.e., the method A (storage type)). At the data flow node, the service entry method calls the method A and transmits the value of the storage type (i.e., “database”) to the method A. The method D is called in the method A, and the value of the storage type is transmitted to the method D. In the method D, the service D is called, and then the data flows into the control flow node (i.e., if storage type equals to “REDIS”). Since an actual value of the storage type is “database”, after performing constraint solving on the control flow node, the processing device may determine that the condition is not satisfied, and accordingly the data flows into the corresponding data flow node (i.e., the data is stored in the database). At the data flow node, the method D calls the database to store the data. Accordingly, by analyzing the business call chain 430 of the service B, the processing device may determine that the service B calls the service D when the value of the business scenario parameter is “live streaming” and the value of the business logic parameter is “database”. Therefore, the processing device may repair a call relationship from the service B to the service D in the business scenario.

FIG. 4E illustrates the exemplary business call chain 440 generated when the value of the business type is “live streaming” and the value of the storage type is “REDIS”. In the example shown in FIG. 4E, at the control flow node in the method entry method, the processing device may perform constraint solving on the control flow node based on the values of the interface incoming parameters. Since the value of the business type is “live streaming”, the condition “business type equals to ‘live streaming’” is satisfied, and the data flows into the corresponding data flow node (i.e., the method A (storage type)). At the data flow node, the service entry method calls the method A and transmits the value of the storage type (i.e., “REDIS”) to the method A. The method D is called in the method A, and the value of the storage type is transmitted to the method D. In the method D, the service D is called, and then the data flows into the control flow node (i.e., if storage type equals to “REDIS”). Since an actual value of the storage type is “REDIS”, after performing constraint solving on the control flow node, the processing device may determine that the condition can be satisfied, and accordingly the data flows into the corresponding data flow node (i.e., the data is stored in REDIS). At the data flow node, the method D calls REDIS to store the data. Accordingly, by analyzing the business call chain 440 of the service B, the processing device may determine that the service B calls the service D when the value of the business scenario parameter is “live streaming” and the value of the business logic parameter is “database”. Therefore, the processing device may repair a call relationship from the service B to the service D in the business scenario.

FIG. 4F illustrates the schematic diagram of the repaired exemplary call chain 450. In the example shown in FIG. 4F, the processing device may repair the call relationship from the service B to the service C based on the business call chain 420 in the service B. Additionally, the processing device may also repair, based on the business call chains 430 and 440 in the service B, the call relationships from the service B to the service D and from the service B to the database 456.

Through the method, the processing device can generate an actual business call chain in the service in a specified business scenario based on the static call chain, thereby repairing the call chains between the services based on the business call chain in the service, reducing the recognized call relationship that does not conform to the business scenario, and improving the accuracy of the repaired call chain.

In some embodiments, the processing device may send data associated with the call chain to a client for displaying at the client. In some embodiments, the processing device may generate a first node corresponding to the first service and a second node corresponding to the second service. The processing device may also generate an edge between the first node and the second node, with the edge indicating a call relationship. Then, the processing device may generate a call graph based on the first node, the second node, and the edge, with the call graph indicating a repaired call chain. In some embodiments, the call graph corresponds to a specific business scenario. In some embodiments, the processing device may send the call graph to the client for displaying the call graph at the client.

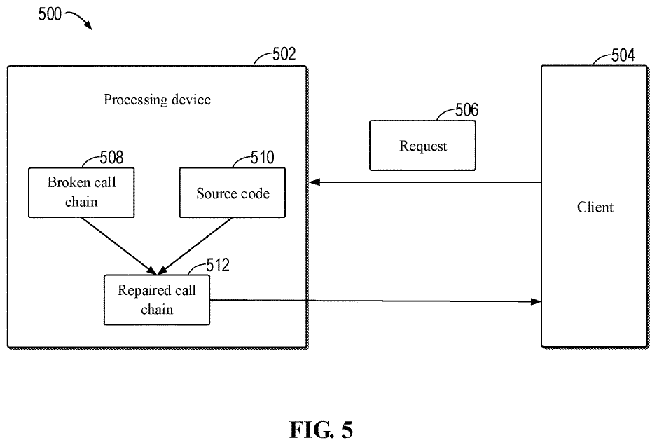

FIG. 5 illustrates a schematic diagram of an example 500 of interaction between a processing device and a client according to some embodiments of the present disclosure. As shown in FIG. 5, the example 500 includes a processing device 502 (e.g., the processing device 102 in FIG. 1) and a client 504. An engineer may send a request 506 for repairing a call chain to the processing device 502 through the client 504. The request 506 may include a broken call chain 508 and a source code 510 (or a storage address of the source code 510). When the engineer determines a service in which the broken chain occurs, the source code 510 may only include a source code of the service in which the broken chain occurs. Then, the processing device may generate a repaired call chain 512 based on the call chain 508 and the source code 510. Then, the processing device 502 may send the repaired call chain 512 to the client 504 for displaying on a display of the client 504.

The processing device 502 may generate a corresponding call chain based on the repaired call chain 512. The call graph may include a plurality of nodes and a plurality of edges connecting the nodes, wherein the plurality of nodes represent a plurality of services, and each edge may indicate a call relationship between two services. Accordingly, the call graph may indicate a repaired call relationship. Additionally, a business scenario corresponding to an interface incoming parameter dynamically collected in the repair process may also be identified in the call graph. Through the method, the engineer can view the call graph on the display of the client 504, thereby improving the efficiency of program analysis.

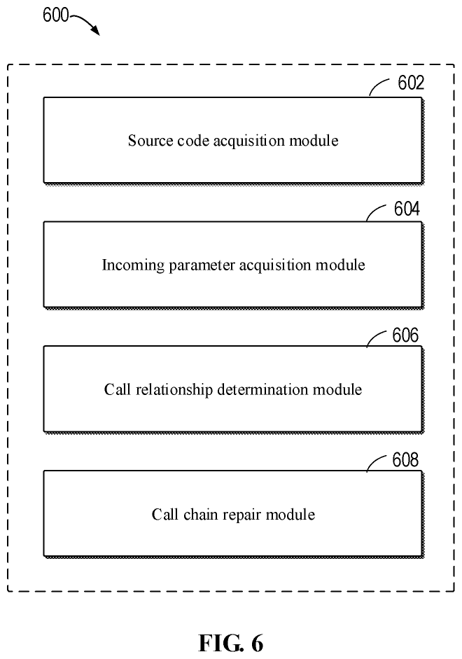

FIG. 6 illustrates a block diagram of an apparatus 600 for repairing a call chain according to some embodiments of the present disclosure. The apparatus 600 includes a source code acquisition module 602, configured to acquire a source code of a first service in the call chain, wherein the call chain also includes a second service, and a call relationship between the first service and the second service is unknown. The apparatus 600 further includes an incoming parameter acquiring module 604, configured to acquire an interface incoming parameter of the first service. The apparatus 600 further includes a call relationship determination module 606, configured to determine the call relationship between the first service and the second service based on the source code and the interface incoming parameter. Additionally, the apparatus 600 further includes a call chain repair module 608, configured to generate a repaired call chain based on the call relationship.

In some embodiments, the incoming parameter acquiring module 604 includes: a parameter interception module, configured to acquire the interface incoming parameter by dynamically intercepting input data of the first service in an operation process of the first service.

In some embodiments, the incoming parameter acquiring module 604 includes: a user input acquisition module, configured to acquire a parameter input by a user as the interface incoming parameter of the first service.

In some embodiments, the call chain is an inter-service call chain. The call relationship determination module 606 includes: an intra-service call chain determination module, configured to determine an intra-service call chain of the first service based on the source code and the interface incoming parameter, wherein the intra-service call chain includes a call relationship between a plurality of methods in a single service; and an intra-service call chain use module, configured to determine the call relationship between the first service and the second service based on the intra-service call chain.

In some embodiments, the intra-service call chain determination module includes: an abstract syntax tree generation module, configured to generate an abstract syntax tree corresponding to the source code based on the source code; a static call chain generation module, configured to generate a static call chain of the first service based on the abstract syntax tree; and a static call chain use module, configured to determine an intra-service call chain based on the static call chain and the interface incoming parameter.

In some embodiments, the intra-service call chain determination module includes: a control flow node determination module, configured to determine a control flow node in the source code; and a control flow node use module, configured to determine the intra-service call chain based on the static call chain, the control flow node, and the interface incoming parameter.

In some embodiments, the interface incoming parameter includes a business scenario parameter and a business logic parameter.

In some embodiments, the control flow node includes a business scenario control flow node associated with a business scenario and a business logic control flow node associated with a business logic. The control flow node use module includes: a first data flow node determination module, configured to determine a first data flow node in the static call chain by solving the business scenario control flow node using the business scenario parameter, wherein the first data flow node is associated with the business logic control flow node; and a first data flow node use module, configured to determine the intra-service call chain based on the first data flow node, the business logic control flow node, and the business logic parameter, wherein the intra-service call chain is associated with the business scenario.

In some embodiments, the first data flow node use module includes: a second data flow node determination module, configured to determine a second data flow node in the static call chain by solving the business logic control flow node using the business logic parameter; and a second data flow node use module, configured to determine the intra-service call chain based on the first data flow node and the second data flow node.

In some embodiments, the intra-service call chain use module includes: a second service determination module, configured to determine that the second service is called at a target data flow node based on the intra-service call chain; and a second service use module, configured to determine that the call relationship exists between the first service and the second service based on the determination of the second service being called.

In some embodiments, the apparatus 600 further includes: a node generation module, configured to generate a first node corresponding to the first service and a second node corresponding to the second service; an edge generation module, configured to generate an edge between the first node and the second node, the edge indicating a call relationship; and a call graph generation module, configured to generate a call graph based on the first node, the second node, and the edge, the call graph indicating a repaired call relationship.

In some embodiments, the call graph corresponds to a specific business scenario.

In some embodiments, the apparatus 600 further includes a call graph sending module, configured to send the call graph to the client for displaying the call graph at the client.

It should be understood that by using the apparatus 600 in the present disclosure, at least one of the many advantages capable of being implemented in the methods or the processes described above may be achieved. For example, the apparatus 600 can achieve a combined dynamic and static program analysis based on the source code of the service and the dynamically acquired interface incoming parameter, thereby improving the accuracy of the repaired call chain. When a value of the interface incoming parameter is changed, the apparatus 600 can repair the call chain for different business scenarios, thereby achieving the call chain analysis at a business link level.

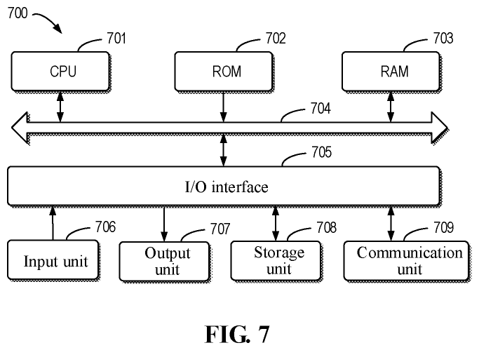

FIG. 7 illustrates a block diagram of a device 700 capable of implementing a plurality of embodiments of the present disclosure. The device 700 may be, for example, the processing device102 shown in FIG. 1. As shown in FIG. 7, the device 700 includes a central processing unit (CPU) and/or a graphics processing unit (GPU) 701, which may perform various appropriate actions and processes according to computer program instructions stored in a read-only memory (ROM) 702 or computer program instructions loaded from a storage unit 708 into a random access memory (RAM) 703. The RAM 703 may also store various programs and data required for the operation of the device 700. The CPU/GPU 701, the ROM 702, and the RAM 703 are connected to one another through a bus 704. An input/output (I/O) interface 705 is also connected to the bus 704. Although not shown in FIG. 7, the device 700 may also include a coprocessor.

A plurality of components in the device 700 are connected to the I/O interface 705, including an input unit 706 such as a keyboard and a mouse; an output unit 707 such as various types of displays and speakers; the storage unit 708 such as a disk and an optical disk; and a communication unit 709 such as a network card, a modem, and a wireless communication transceiver. The communication unit 709 allows the device 700 to exchange information/data with other devices through a computer network such as the Internet, and/or various telecommunication networks.

The various methods or processes described above may be performed by the CPU/GPU 701. For example, in some embodiments, the method may be implemented as a computer software program that is tangibly included in a machine-readable medium, such as the storage unit 708. In some embodiments, part or all of the computer program may be loaded and/or installed onto the device 700 via the ROM 702 and/or the communication unit 709. When the computer program is loaded onto the RAM 703 and executed by the CPU/GPU 701, one or more of steps or actions of the methods or the processes described above may be performed.

In some embodiments, the methods and the processes described above may be implemented as a computer program product. The computer program product may include a computer-readable storage medium carrying computer-readable program instructions for performing various aspects of the present disclosure.

The computer-readable storage medium may be a tangible device that may retain and store instructions used by an instruction-executing device. The computer-readable storage medium may be, for example, but is not limited to, an electric storage device, a magnetic storage device, an optical storage device, an electromagnetic storage device, a semiconductor storage device, or any suitable combination of the above. More specific examples (a non-exhaustive list) of the computer-readable storage medium include: a portable computer disk, a hard drive, a random access memory (RAM), a read-only memory (ROM), an erasable programmable read-only memory (EPROM or a flash memory), a static random access memory (SRAM), a portable compact disk read-only memory (CD-ROM), a digital versatile disc (DVD), a memory stick, a floppy disk, a mechanical encoding device, such as a punch card or a raised structure in a groove with instructions stored therein, and any suitable combination of the above. The computer-readable storage medium used herein is not to be interpreted as transient signals, such as radio waves or other freely propagating electromagnetic waves, electromagnetic waves propagated through waveguides or other transmission media (e.g., light pulses through fiber-optic cables), or electrical signals transmitted through wires.

The computer-readable program instructions described herein may be downloaded from the computer-readable storage medium to various computing/processing devices or downloaded to an external computer or an external storage device through a network, such as the Internet, a local area network, a wide area network, and/or a wireless network. The network may include a copper transmission cable, optical fiber transmission, wireless transmission, a router, a firewall, a switch, a gateway computer, and/or an edge server. A network adapter card or a network interface in each computing/processing device receives the computer-readable program instructions from the network and forwards the computer-readable program instructions for storage in the computer-readable storage medium in each computing/processing device.

The computer program instructions for performing the operations of the present disclosure may be assembly instructions, instruction set architecture (ISA) instructions, machine instructions, machine-dependent instructions, microcode, firmware instructions, state setting data, or source code or object code written in any combination of one or more programming languages, wherein the programming languages include object-oriented programming languages and conventional procedural programming languages. The computer-readable program instructions may be executed entirely on a user computer, partly on the user computer, as a stand-alone software package, partly on the user computer and partly on a remote computer, or entirely on the remote computer or the server. In the case of the remote computer, the remote computer may be connected to the user computer through any type of network, including a local area network (LAN) or a wide area network (WAN), or may be connected to the external computer (e.g., utilizing an Internet service provider for Internet connectivity). In some embodiments, an electronic circuit, such as a programmable logic circuit, a field programmable gate array (FPGA), or a programmable logic array (PLA), is customized by utilizing state information of the computer-readable program instructions. The electronic circuit may execute the computer-readable program instructions so as to implement various aspects of the present disclosure.

These computer-readable program instructions may be provided to a processing unit of a general-purpose computer, a special-purpose computer, or another programmable data processing apparatus, thereby producing a machine, such that these instructions, when executed by the processing unit of the computer or another programmable data processing apparatus, produce an apparatus for implementing functions/actions specified in one or more blocks in the flowcharts and/or the block diagrams. These computer-readable program instructions may also be stored in the computer-readable storage medium, and these instructions cause the computer, the programmable data processing apparatus, and/or another device to operate in a specific method; and therefore, the computer-readable medium having instructions stored therein includes a product that includes instructions for implementing various aspects of the functions/actions specified in one or more blocks in the flowcharts and/or the block diagrams.

The computer-readable program instructions may also be loaded to the computer, the another programmable data processing apparatus, or the another device, such that a series of operating steps are performed on the computer, the another programmable data processing apparatus, or the another device to produce a computer-implemented process, and accordingly, the instructions executed on the computer, the another programmable data processing apparatus, or the another device implement the functions/actions specified in one or more blocks in the flowcharts and/or the block diagrams.

The flowcharts and the block diagrams in the accompanying drawings illustrate the possibly implemented system architectures, functions, and operations of the device, the method, and the computer program product according to the plurality of embodiments of the present disclosure. In this regard, each block in the flowcharts or the block diagrams may represent a module, a program segment, or a portion of instruction, and the module, the program segment, or the portion of instruction includes one or more executable instructions for implementing specified logical functions. In some alternative implementations, functions marked in the blocks may also occur in an order different from that marked in the accompanying drawings. For example, two successive blocks may actually be executed in parallel substantially, and sometimes may also be executed in a reverse order, depending on functions involved. It should be further noted that each block in the block diagrams and/or the flowcharts, as well as a combination of the blocks in the block diagrams and/or the flowcharts may be implemented by using a dedicated hardware-based system that executes specified functions or actions, or using a combination of dedicated hardware and computer instructions.

The embodiments of the present disclosure have been described above. The above-mentioned description is exemplary, rather than exhaustive, and is not limited to the disclosed various embodiments. Numerous modifications and variations are apparent to those of ordinary skill in the art without departing from the scope and spirit of the described embodiments. The selection of the terms as used herein is intended to best explain the principles and practical applications of the various embodiments, or technology improvements to technologies on the market, or to allow other persons of ordinary skill in the art to understand the various embodiments disclosed herein.

I/We claim:

1. A method for repairing a call chain, comprising:
acquiring a source code of a first service in the call chain, the call chain further comprising a second service, and a call relationship between the first service and the second service being unknown;
acquiring an interface incoming parameter of the first service;
determining the call relationship between the first service and the second service based on the source code and the interface incoming parameter; and
generating a repaired call chain based on the call relationship.

2. The method according to claim 1, wherein acquiring the interface incoming parameter of the first service comprises:
acquiring the interface incoming parameter by dynamically intercepting incoming data of the first service in an operation process of the first service.

3. The method according to claim 1, wherein acquiring the interface incoming parameter of the first service comprises:
acquiring a parameter input by a user as the interface incoming parameter of the first service.

4. The method according to claim 1, wherein the call chain is an inter-service call chain, and determining the call relationship between the first service and the second service based on the source code and the interface incoming parameter comprises:
determining an intra-service call chain of the first service based on the source code and the interface incoming parameter, the intra-service call chain comprising a call relationship between a plurality of methods in a single service; and
determining the call relationship between the first service and the second service based on the intra-service call chain.

5. The method according to claim 4, wherein determining the intra-service call chain of the first service based on the source code comprises:
generating an abstract syntax tree corresponding to the source code based on the source code;
generating a static call chain of the first service based on the abstract syntax tree; and
determining the intra-service call chain based on the static call chain and the interface incoming parameter.

6. The method according to claim 5, wherein determining the intra-service call chain based on the static call chain and the interface incoming parameter comprises:
determining a control flow node in the source code; and
determining the intra-service call chain based on the static call chain, the control flow node, and the interface incoming parameter.

7. The method according to claim 6, wherein the interface incoming parameter comprises a business scenario parameter and a business logic parameter.

8. The method according to claim 7, wherein the control flow node comprises a business scenario control flow node associated with a business scenario and a business logic control flow node associated with a business logic, and determining the intra-service call chain based on the static call chain, the control flow node, and the interface incoming parameter comprises:
determining a first data flow node in the static call chain by solving the business scenario control flow node using the business scenario parameter, wherein the first data flow node is associated with the business logic control flow node; and
determining the intra-service call chain based on the first data flow node, the business logic control flow node, and the business logic parameter, wherein the intra-service call chain is associated with the business scenario.

9. The method according to claim 8, wherein determining the intra-service call chain based on the first data flow node, the business logic control flow node, and the business logic parameter comprises:
determining a second data flow node in the static call chain by solving the business logic control flow node using the business logic parameter; and
determining the intra-service call chain based on the first data flow node and the second data flow node.

10. The method according to claim 4, wherein determining the call relationship between the first service and the second service based on the intra-service call chain comprises:
determining that the second service is called at a target data flow node based on the intra-service call chain; and
determining that the call relationship exists between the first service and the second service based on the determination of the second service being called.

11. The method according to claim 1, further comprising:
generating a first node corresponding to the first service and a second node corresponding to the second service;
generating an edge between the first node and the second node, the edge indicating the call relationship; and
generating a call graph based on the first node, the second node, and the edge, the call graph indicating a repaired call relationship.

12. The method according to claim 11, wherein the call graph corresponds to a specific business scenario.

13. The method according to claim 12, further comprising:
sending the call graph to a client for displaying the call graph at the client.

14. An electronic device, comprising:
a processor; and
a memory coupled with the processor, wherein the memory has instructions stored therein, and the instructions, when executed by the processor, cause the electronic device to:
acquire a source code of a first service in the call chain, the call chain further comprising a second service, and a call relationship between the first service and the second service being unknown;
acquire an interface incoming parameter of the first service;
determine the call relationship between the first service and the second service based on the source code and the interface incoming parameter; and
generate a repaired call chain based on the call relationship.

15. The electronic device according to claim 14, wherein the instructions causing the electronic device to acquire the interface incoming parameter of the first service further cause the electronic device to:
acquire the interface incoming parameter by dynamically intercepting incoming data of the first service in an operation process of the first service.

16. The electronic device according to claim 14, wherein the instructions causing the electronic device to acquire the interface incoming parameter of the first service further cause the electronic device to:
acquire a parameter input by a user as the interface incoming parameter of the first service.

17. The electronic device according to claim 14, wherein the call chain is an inter-service call chain, and the instructions causing the electronic device to determine the call relationship between the first service and the second service based on the source code and the interface incoming parameter further cause the electronic device to
determine an intra-service call chain of the first service based on the source code and the interface incoming parameter, the intra-service call chain comprising a call relationship between a plurality of methods in a single service; and
determine the call relationship between the first service and the second service based on the intra-service call chain.

18. The electronic device according to claim 17, wherein the instructions causing the electronic device to determine the intra-service call chain of the first service based on the source code further cause the electronic device to:
generate an abstract syntax tree corresponding to the source code based on the source code;
generate a static call chain of the first service based on the abstract syntax tree; and
determine the intra-service call chain based on the static call chain and the interface incoming parameter.

19. The electronic device according to claim 18, wherein the instructions causing the electronic device to determine the intra-service call chain based on the static call chain and the interface incoming parameter further cause the electronic device to:
determine a control flow node in the source code; and
determine the intra-service call chain based on the static call chain, the control flow node, and the interface incoming parameter.

20. A computer program product, wherein the computer program product is tangibly stored on a non-transitory computer-readable medium and comprises machine-executable instructions, and the machine-executable instructions, when executed, cause a machine to:
acquire a source code of a first service in the call chain, the call chain further comprising a second service, and a call relationship between the first service and the second service being unknown;
acquire an interface incoming parameter of the first service;
determine the call relationship between the first service and the second service based on the source code and the interface incoming parameter; and
generate a repaired call chain based on the call relationship.
